(19) United States
(12) Patent Application Publication
(10) Pub. No.: US 2007/0011325 A1
(43) Pub. Date: Jan. 11, 2007

(54) Protocol mediation for adaptation in semantic web services

(76) Inventor: Stuart Kennedy Williams, Bristol (GB)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/413,598

(22) Filed: Apr. 28, 2006

(30) Foreign Application Priority Data
Apr. 29, 2005 (GB) 0508805.9

(51) Int. Cl. G06F 15/173

(52) U.S. Cl. 709/225

(57) ABSTRACT

A method of invoking a web service comprising the steps of: generating a generic client module for requesting web services, the generic module being adapted to output commands invoking web services in conformity with a canonical model of commercial activities in a given commercial domain; and generating, from the canonical model and information relating to a syntax used to invoke web services at an enterprise, an adaptation module, adapted to receive commands output by the generic module, and express those commands as one or more commands having a syntax by which web services may be directly invoked at the enterprise.

### BACKGROUND TO THE INVENTION

1. Field of the Invention

The present invention relates to the provision of web services as well as to the manner in which web services are used. The term ‘web service’ is a term of art and relates, inter alia, to computational operations at a server computer (‘server’), for example, which may be invoked by a request for the performance of such an operation from a client computer (‘client’). Thus, web services are most typically those operations which are not experienced by human users of computers.

2. Description of Related Art

In order to enable the invocation (i.e. the request and implementation) of a web service performed at a server, the server may typically expose a description of the web services which may be invoked at it. This is usually known as a web service description and is most typically written in a standard format known as Web Service Description Language (WSDL). This provides a would-be user of the web services with the syntax required by a client to invoke the services available at the server.

A typical example of a web service or services is in the domain of online shopping. In this domain, the services which are available to a client, the manner in which those services are configured and the way they may be invoked by a client is apt to differ from one enterprise to another. This is typically a the result of a combination of different commercial considerations or models from one enterprise to another and partly a simple artefact of different authorship of the code which provides the web services. Thus, to invoke web services provided by different enterprises a user will typically need to configure a whole series of clients, each effectively, being bespoke for the web service or services it wishes to invoke. This burden can act as a significant hindrance to the use of automated clients for invoking web services provided by multiple enterprises. Further, the nature of WSDL is such that, while a web service description written in WSDL provides the syntax which must be used to invoke the services and an indication of what those services are, for more complex aggregations of services, that is to say, aggregations of related functions which are capable of invocation remotely to provide an overall service which provides at least some of the functionality of the commercial domain (which is what will often be present in all but the most simple commercial domains) a description written in WSDL does not provide a very clear exposition of the architecture of the aggregated web service. This means that configuring a client to invoke the various elements of the ‘aggregated’ web service can be a long and time-consuming task. Further, whenever any material element of the aggregated web service changes (due, for example, to an upgrade), the client requires corresponding reconfiguration. It follows that, configuring multiple clients to invoke many different aggregated web services is a substantial burden. The result is that the automated commercial exploitation of web services is not as extensive as otherwise it might be.

### SUMMARY OF THE INVENTION

One aspect of the present invention provides a more extensive exposition of an aggregated web service by the service provider. A further aspect of the present invention provides the use of the enhanced web service exposition to generate, automatically, client-code to interact with the web service.

A method of invoking web services provided by an enterprise within a given commercial domain
generating, within a client, generic output commands for invoking web services which conform with a canonical model of commercial activities in the commercial domain;
receiving the generic output commands prior to their arrival at the enterprise, and expressing the received generic commands as one or more commands having a syntax by which web services may be directly invoked at the enterprise;
transmitting the enterprise-specific commands to the enterprise to invoke web services provided by the enterprise, and expressing those commands as one or more commands having a syntax by which web services may be directly invoked at the enterprise.

A further aspect of the present invention provides a client for requesting web services from an enterprise operating in a commercial domain, comprising:
a generic client module, adapted to issue commands to a server to provide web services in accordance with a canonical model of the commercial domain;
an adaptation module, adapted to receive the commands output from the generic client module and to express those commands as one or more commands in a syntax by which web services may be directly invoked at the enterprise.

### BRIEF DESCRIPTION OF DRAWINGS

Embodiments of the invention will now be described, by way of example, and with reference to the accompanying drawings, in which:

FIGS. 1 and 2 are schematic illustrations of a scenario in which web services are available and how they may be invoked;

FIG. 3 is a schematic illustration of the architecture for the creation of an adaptation module;

FIG. 4 is a simple flowchart illustrating the sequence of operations involved in transforming canonical commands to enterprise-specific commands which can be invoked as web services

FIG. 5 is a state machine diagram of a canonical model for a specific commercial domain;

FIGS. 6a-c are state machine diagrams of enterprise-specific operations conforming to the canonical model which are invocable as web services; and

FIGS. 7a-c are state machine diagrams of enterprise-specific operations which do not conform to the canonical model yet are invocable as web services via transformations.

### DESCRIPTION OF PREFERRED EMBODIMENTS

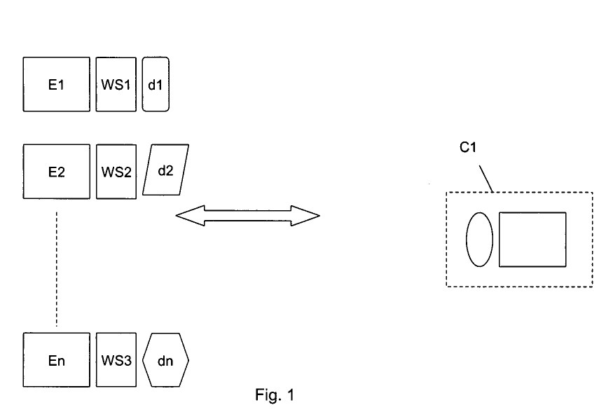

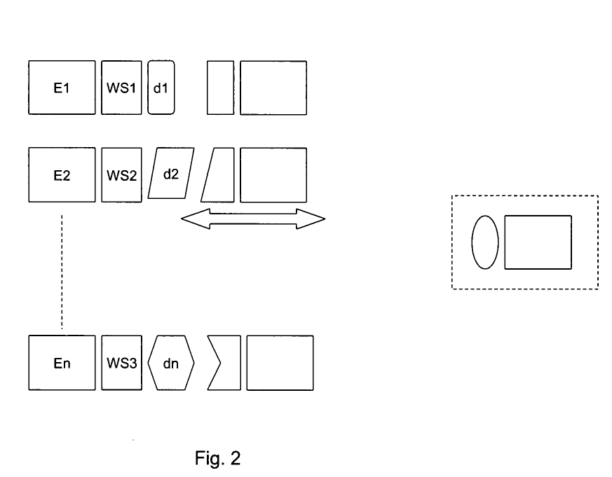

Referring now to FIGS. 1 and 2, a plurality of commercial enterprises offer the opportunity to contract for the provision of goods and/or services via aggregated web services. In the present example, the enterprises are supermarkets or general grocery stores; this provides an easy example but the principles are applicable generally. Each of the enterprises, E1, E2 . . . En operate in the same commercial domain, so that, at a most abstract level, the same commercial canons of operation apply; for example, each enterprise will be offering items for sale which will require payment from a customer and delivery of the item to the customer. What differs from enterprise to enterprise, therefore, is either the manner in which the seminal commercial operations required profitably to conduct business are put into practice and/or the way in which the web services which provide the ability to conduct those commercial activities by means of remotely invocable machine-executed operations are authored.

Thus, for example, enterprise E1 provides for online shopping, selling groceries. Its commercial model is that products are available for selection via a website, the customer selects products to purchase, selects the time of delivery, renders payment and the goods are subsequently delivered to the customer. At that level of abstraction, enterprises E2. . . . En operate in an identical manner. However, once greater precision is required to describe the manner of operation, differences begin to emerge. Thus, enterprise E1 offers its products for sale by means of an aggregated set of web services WS1. These services are described in a web services description document d1 and the relative singularity of the web services which the document d1 describes is symbolically illustrated by the topography of the element in the drawing representing d1. Similarly, the enterprise E2 offers its products for sale via aggregated web services WS2, described in a web services description document d2. Again, the singular character of the web services WS2 (as opposed to the abstract commercial operations which they enable Enterprise E2 to conduct online) is illustrated by a singular topography for the web services description document d2.

Also illustrated in FIGS. I and 2, is a client computing entity, C1. The client is effectively a software agent operating on behalf of a user. The user wishes to deploy the agent on the task of automatic procurement. Typically this is likely to occur in a commercial context where, for example, an organisation which is a large-scale consumer of groceries (in the context of the present example) seeks to obtain the best price and delivery on a regular basis from one of a number of potential suppliers. In the event it is possible to automate the process of procurement to achieve this, then fluctuations in prices offered by the various enterprises can be exploited to ensure that the very lowest price available for the goods required is paid on each occasion. This is only possible, however, provided that and to the extent to which the agent is capable of invoking the web services of each of the candidate enterprises E1 . . . En. Given that each aggregated set of web services is likely, as described above, to differ firstly because of their different commercial implementations of the canonical model of online sale and secondly because of the different authorship of the code which provides the web services which may be invoked in order remotely to select goods and contract for their sale, a different, bespoke client is effectively required for each enterprise.

The client agent can be thought of—and again this is an abstraction which assists in the understanding of the scenario—as having two modules. The first module, 10 is generic to the domain of online grocery procurement and, accordingly, includes all of those elements which, necessarily, are present in each web service regardless of which enterprise's commercial activities the service is implementing. The second module, 20 is the part of the client agent which is particular to the specific web service with which the agent is configured to operate. Thus, as shown in FIG. 2, what is required in order to engage in such a procurement process, is that, for each enterprise a client includes a bespoke module 20 which is adapted to operate with the specific web services which are provided by the enterprise to implement the canonical commercial model of the commercial domain in question.

The creation of a bespoke module is a significant burden for a potential user. Particularly in view of the probability that the web services for each of the enterprises may frequently alter as a result of upgrades to the code which is written to provide it—necessitating further, corresponding modifications to the bespoke module. Accordingly, one aspect of the present invention provides that the web services of each of the enterprises are exposed in a manner that enables the description exposing them to be used automatically to generate a client to invoke them. This effectively shifts the burden of creating a suitable client, or at least a significant part of it, onto the enterprise which will, ultimately benefit from having a client configured to invoke the corresponding web services.

A first aspect of the present invention therefore lies in the concept of the provision, by enterprises, of a ‘rich’ description of their aggregated web services which are used to implement the commercial model of the enterprise. By the term ‘rich’ in this context, is intended to denote a relatively detailed and precise description of
(a) the canonical model of enterprise activity in the commercial domain in question—here online grocery sale. In more detail, this includes: the data structure which is employed in a machine-readable form (such as, for example, Resource Description Framework (RDF) or Web Ontology Language (OWL); the nature of the operations which may be performed; and the sequencing constraints which exist in relation to those operations. Alternatively, a reference to the model which is adopted (i.e. a reference to the location which information on such a model is kept) can be included.
(b) the syntax through which this model is materialised. Specifically, this includes the transformations from commands which are generic (i.e. commands which apply within the canonical model and are therefore vendor unspecific) to vendor-specific commands, and well as a description of the various vendor-specific commands.

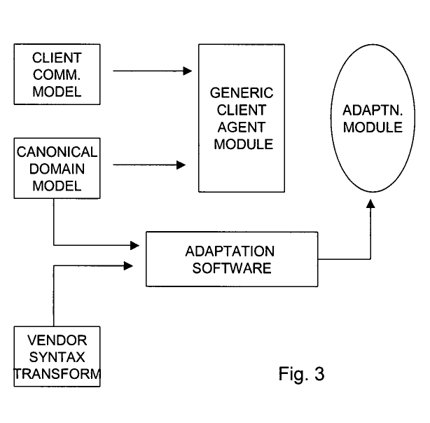

Referring now to FIG. 3, these elements can be used as follows. By reference to the canonical model 30 and the user's commercial objectives 32 the user writes the generic client-side agent module 10 for procuring groceries in the manner which is most advantageous to him having regard to his commercial objectives. This agent is expressed using the generic commands for operations which are available within the boundaries of the canonical model for the domain of online grocery shopping. To write this model, the user will, in addition to the commands available for the generic operations which are within the boundaries of the model, also require the data structure which is adopted within that commercial domain. Thus, for example, the data structure of an ‘item’ which is to be purchased may include the following fields:
item description (i.e. one or more text strings by which human users who are searching for or seeking to recognise an item may identify that item);
size;
delivery date;
unit price;
discount;
loyalty token value;

It is not mandatory to include each of these fields within an item and one or more can, optionally, be ‘null’ fields, such as, for example the discount and/or loyalty token value.

Having created the generic module 10, the user then employs automated adaptation software 40 to express the various generic canonical domain commands in enterprise-specific syntax; the adaptation software additionally maps the generic commands to the vendor-specific command (or, where appropriate group or sequence of commands) which are required in order to implement, at the enterprise in question, the operation executed by each of the canonical commands. The automatic adaptation software 40 and the manner of its creation is described in some detail in the Appendix hereto. The result is the creation of an adaptation module 20. Once this operation is complete, the combination of the generic client module 10 and the adaptation module 20 is such as to amount to a bespoke client for the enterprise in respect of which the adaptation module has been created.

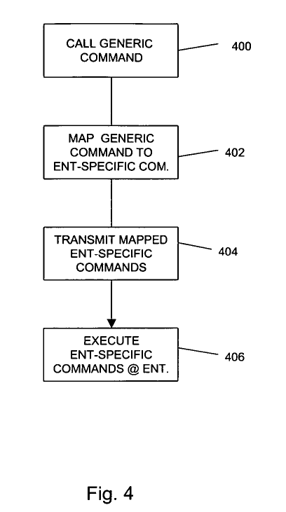

Referring now to FIG. 4, at an abstract level, the manner in which these elements combine to invoke one or more web services is as follows. At step 400 the generic module 10 calls for the execution of one or more web service elements available within the aggregated web service of an enterprise and which are such as to conform to the user's commercial model of operation. An example of this might, for example, be to seek to obtain a quote for a number of specified ‘items’ (i.e. groceries) for delivery on a particular day. This is output from the generic module as a sequence of the generic operations (which can be thought of as ‘commands’ though some operations are not, strictly speaking, commands since they may, for example, be responses to commands) which conform to the canonical model. These generic commands are then passed through the adaptation module, which, at step 402, applies the requisite transformations in order to express each generic command as one or more of the enterprise-specific commands necessary to achieve the same result. These are then sent to the server of the enterprise at step 404 and, at step 406 are executed as the enterprise-specific commands. Thus, the enterprise's exposition of a rich description of its web services has enabled the user, by means of the automatic adaptation software, to invoke the enterprise's web services even though the user's client is written to call for the execution of commands in the generic language of the domain.

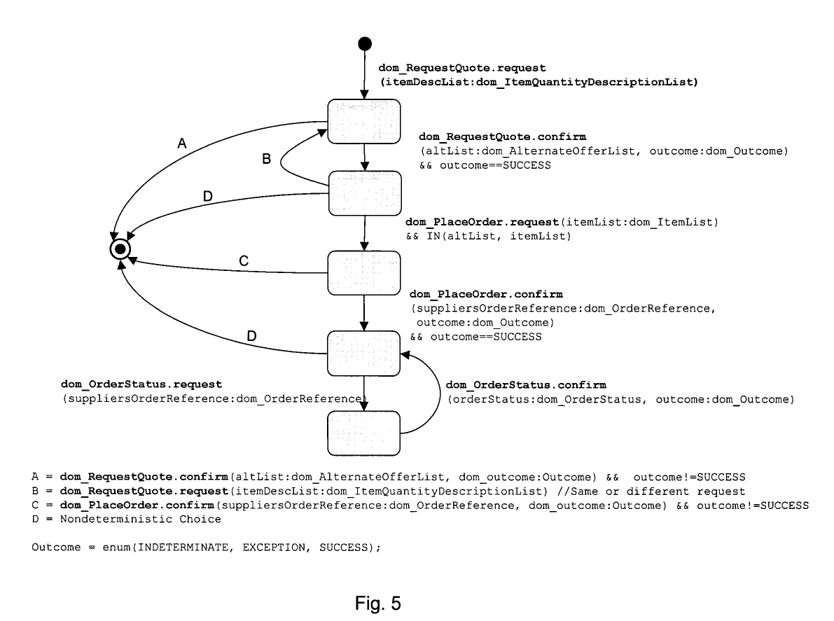

A specific example will now be described. Referring now to FIG. 5, a canonical model for online grocery shopping is illustrated as a state machine. The model has, in essence, three seminal operations:
dom_RequestQuote—obtain a price in relation to a specified item or list of items
dom_PlaceOrder—a contractual action which involves agreement to purchase an item or list of items
dom_OrderStatus—an inquiry-related operation determining the status of an order.

The “dom” prefix indicates that the operation is domain-level, i.e. canonical and therefore generic to all commercial operation within that commercial domain. Each of these operations has two parts:
.request—this initiates the related operation and conveys input parameters
.confirm—this concludes the related operation and conveys its results

The fist operation which is generic to the domain of online grocery shopping is:
dom_RequestQuote.request

As stated above, the suffix ‘dom’ in this notation indicates that this is an operation a generic type to the entire domain and is therefore canonical. This operation—here a command—requests a list of items requested by reference to the description of items for which quotes were requested. The input parameters of the operation are
itemDescList:dom_ItemQuantityDescriptionList
   that is to say the variable
itemDescList
   whose data type is specified as
dom_ItemQuantityDescriptionList
   i.e. a description list containing a range of possible values for item and quantity. This list will, essentially be a list of all the possible items which conform to the description or descriptions submitted, together with the quantities. An example might be, say a description of ‘Strawberry Jam’ which then returns a list of all Strawberry Jams, the size of the jars and their price. A further, alternative transition within the state machine is that illustrated by transition A, which is simply the case where, for whatever reason, the operation is not successful and the process ends.

The next operation (and here, not a command) in the canonical model is
dom_RequestQuote.confirm

This transition in the state machine represents the return to the client of
altList
   i.e. the list of the range of items within the definition specified in the parameters of the .request command. The alternative transition of the state machine, transition B, is also possible after this operation, this taking place simply when the client seeks yet another request rather than choosing to progress on the basis of the items returned in response. A further alternative transition is simply transition D, which is the termination of the process on reaching the state of receiving a list.

This transition in the state machine is then followed by the transition representing the command
don_PlaceOrder.request
   which amounts to an offer to purchase those items which are specified in
itemlist

This is followed either by transition C, which is simply termination, or by the transition
don_Placeorder.confirm
   which is the contractual acceptance to the offer to purchase and returns the value
supplierOrdersReference

At this point there are two alternative transitions: transition D which, once again, is simply termination, or the first of two transitions occasioned by the canonical operation:
dom_OrderStatus
   which, respectively, are a request by a client for a status on an existing order, and a reply to a request of that kind by the enterprise.

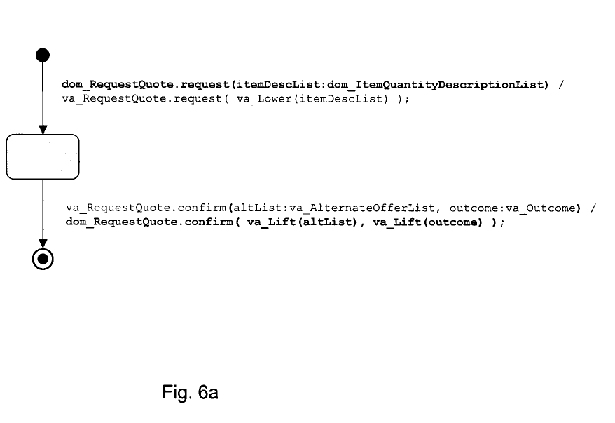

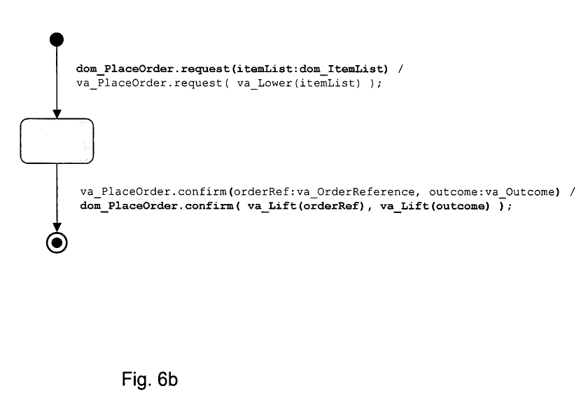

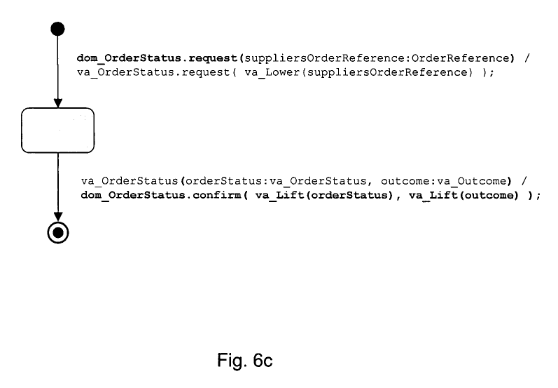

This canonical model, as a result of its generic character, can naturally be implemented by an enterprise in a number of ways. Thus, referring now to FIGS. 6, one very simple way in which an enterprise may implement the canonical model is simply to implement each of the generic operations directly. Thus, referring to FIG. 6a, the initial transition of the state machine signifies the user generating and calling for execution of the RequestQuote.request operation in respect of a list of item descriptions. This passes through the adaptation module 20 which (in the operation denoted as
va_lower(itemDescList)

converts the generic, canonical-level operation to the enterprise specific (here Vendor a—indicated by va) syntax for invoking that web service element, this ‘downward’ conversion being signified in this notation by ‘lower’ The next transition signifies the server at the enterprise returning a list
altlist:va_AlternativeofferList
   which is transformed by the adaptation module to the syntax of the canonical model as signified by
va_Lift(altlist)

Similar operations, involving transformations to and from vendor-specific syntax, are similarly illustrated by transitions in the state machines shown in FIGS. 6b and c and are represented by the canonical operations: PlaceOrder and OrderStatus.request

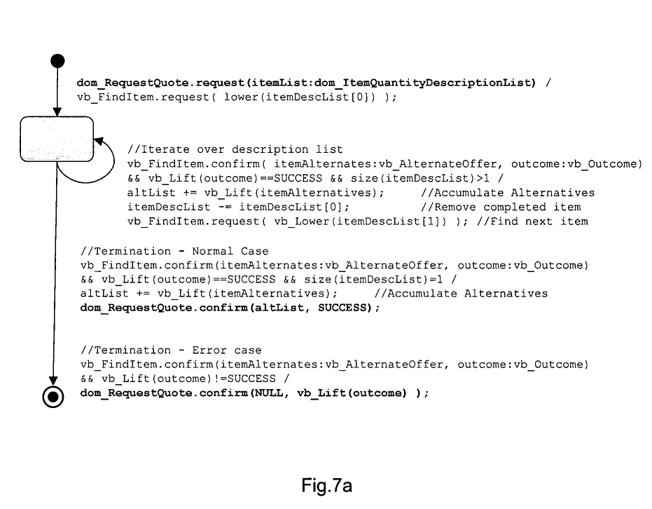

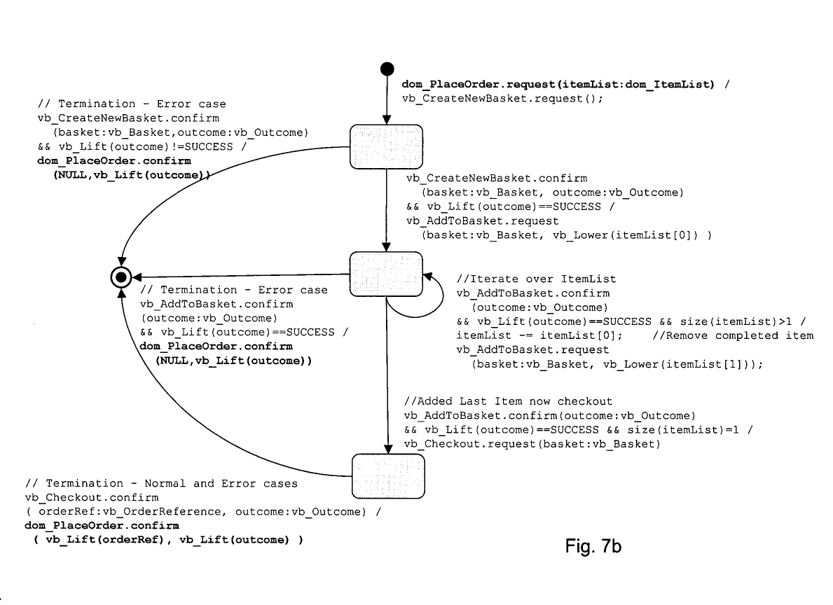

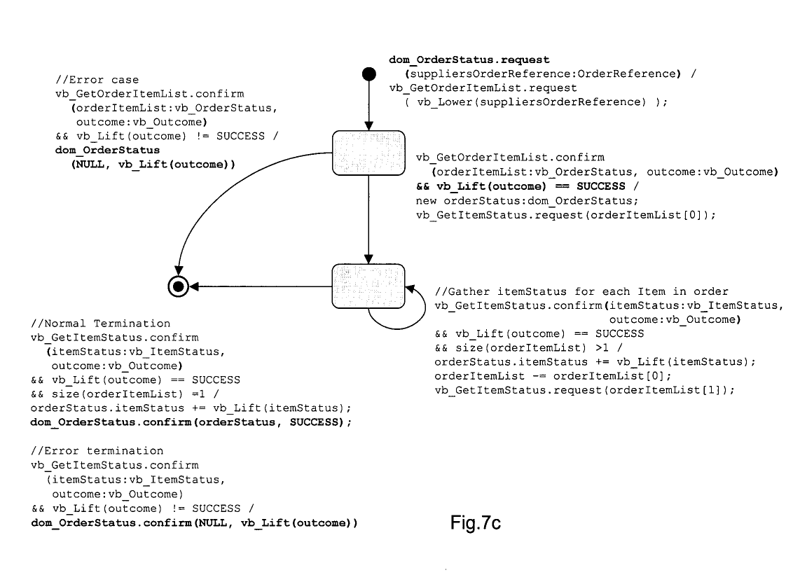

There may, however, be instances in which an Enterprise's manner of doing commerce does not conform to the canonical model of the domain. Referring now to FIG. 7a, unlike the canonical model where a requested list of items (by description) is submitted to an enterprise, and, in response to a request for such a list, a list of items which are identified as conforming to that description is returned, this enterprise has what can be thought of as a ‘browse and add to cart’ model. Thus, the web services of this enterprise does not have a command which is invocable to create a list of items, either by description or otherwise. Rather, the web service is only capable of creating a shopping basket, and adding a selected item which has been retrieved in response to a search request for a single description of item, to the basket, before browsing once again for further items. Accordingly, it follows that, a list of items cannot, without more, be retrieved. This difference can be dealt with, however, by using the automatic adaptation software which, on the basis of the canonical model of the generic operations which can be processed and called by the generic client module together with the exposed web service description from the enterprise, which shows both the syntax of the enterprise-specific web service commands and the transformation which are required in order to express those canonical operations as enterprise-specific commands, i.e. commands which are capable of being invoked by the enterprise, creates an adaptation module 20 which is capable of operating with the enterprise-specific syntax.

Thus, in FIG. 7a, the adaptation module receives a standard command conforming to the generic operation dom_Requestquote.request, i.e. a request for a list of items conforming to a description. This is not assimilable to invoke a web service at that specific enterprise. However, the adaptation module 20 transforms the command so that it is converted into a series of individual enterprise-specific commands which are passed over to the web service, and therefore are invoked at the web service, one at a time. This process is entirely invisible, however, at the generic module, since to the user, the items which are returned, are transformed back so that they are assimilable by him as a list; the result being that this simply appears as execution of his client request to invoke a web service returning an list of items corresponding to a description, according to the canonical model. Similar operations are performed, transforming a list of operations into serial commands which can be invoked in the enterprise-specific syntax which supports the “browse for an item and then add to the cart” model of operation, in FIG. 7b, where an order consisting of plural items is created by the creation of a shopping basket and then the repeated addition to the basket until it contains all of the items on the list. The list is then sequentially emptied of those items until all have been removed at which point the basket as a whole is basket is then checked-out as a whole The basket is then sequentially emptied of those items until all have been removed whereupon the basket as a whole is ‘checked out’; this gives rise to the placement of an order. Finally, further transformations are illustrated in FIG. 7c for inquiring about the status of orders. In this way, by transforming generic commands to one or more enterprise-specific commands, a vendor whose web services do not conform to the canonical model for the domain in which he is operating, may nonetheless serve a client which is created in accordance with that canonical model. Further, because the vendor takes the burden of providing the transformation, the burden on the client is small, since all that is required is the automated adaptation process, which can be thought of as a selection of the appropriate and necessary transformations made available by the vendor. The automated adaptation creation software, as explained previously, can be implemented as described in detail in the accompanying Appendix 1 hereto.

In the description, the adaptation module is described as being adapted for a single enterprise-specific syntax and, in FIGS. 1 and 2, for the purpose of conceptual understanding, different, distinct adaptation modules are illustrated. This is not, however, necessary. Since the module effectively contains a series of the relevant transformations between the syntax of a particular enterprise and the commands which are in conformance with the canonical model, the module is, effectively, ‘cumulatively’ capable. By which is meant that it is capable of operating with each specific enterprise syntax for which it has been provided with the transformations by the automatic adaptation software. Thus a single module may provide adaptation to plural enterprise specific syntaxes.

In the embodiments thus far illustrated, the adaptation module is an integral part of the client requesting the web services. Thus, each client has the burden, albeit limited, of creating an adaptation module. In a modification, the adaptation of vendor-specific syntax to canonical operations can itself be provided as a web service. The clients of this Adaptation web service are the generic client modules written by the various users, and the Service itself would sit interstitial of the client module and the ultimate Enterprise web service, providing the transformations for the client to request a web service from one or more specified vendors.

1. A method of invoking web services provided by an enterprise within a given commercial domain,
generating, within a client, generic output commands for invoking web services which conform with a canonical model of commercial activities in the commercial domain;
receiving the generic output commands prior to their arrival at the enterprise, and expressing the received generic commands as one or more commands having a syntax by which web services may be directly invoked at the enterprise;
transmitting the enterprise-specific commands to the enterprise to invoke web services provided by the enterprise, and expressing those commands as one or more commands having a syntax by which web services may be directly invoked at the enterprise.

2. A method according to claim 1, further comprising the steps of, receiving, from the enterprise, data generated by the invocation of a web service at the enterprise, and transforming the data into a form conforming to a data set capable of creation by a command output directly from the generic module.

3. A method according to claim 1 wherein the canonical model and syntax are contained in a description held by the enterprise

4. A method according to claim 1 wherein a description of an enterprise's web service includes a pointer to the canonical model.

5. A client for requesting web services from an enterprise operating in a commercial domain, comprising:
a generic client module, adapted to issue commands to a server to provide web services in accordance with a canonical model of the commercial domain;
an adaptation module, adapted to receive the commands output from the generic client module and to express those commands as one or more commands in a syntax by which web services may be directly invoked at the enterprise.

6. A client according to claim 5, wherein the adaptation module is further adapted to transform data generated by the execution of a web service at the enterprise into data having a form created by the execution of one or more web services which conform to the canonical model.

7. A client according to claim 5 wherein the adaptation module is adapted to express commands in plural, enterprise-specific syntaxes.

8. A web service adapted to:
receive output commands seeking to invoke web services from one or more enterprises, the output commands conforming with a syntax of a canonical model of a commercial domain in which the or each enterprise operates;
retain mappings of canonical commands to one or more enterprise-specific commands expressed in a syntax through which web services of the enterprise may be invoked;
express canonical commands input from a client as one or more commands in enterprise-specific syntax and to transmit those enterprise-specific commands to an enterprise, thereby to enable invocation of a web service at the enterprise by a client adapted to output commands in generic syntax.

9. A web service according to claim 8 further adapted to transform messages from enterprises into messages in canonical syntax.
